(19) United States
(12) Patent Application Publication
(10) Pub. No.: US 2026/0110577 A1
(43) Pub. Date: Apr. 23, 2026

(54) INFRARED SENSOR ELEMENT, INFRARED SENSOR, AND POSITION DETECTION SYSTEM

(71) Applicant: Murata Manufacturing Co., Ltd., Nagaokakyo-shi (JP)

(72) Inventor: Keitaro TAMURA, Nagaokakyo-shi (JP)

(21) Appl. No.: 19/424,702

(22) Filed: Dec. 18, 2025

Related U.S. Application Data
(63) Continuation of application No. PCT/JP2024/020176, filed on Jun. 3, 2024.

(30) Foreign Application Priority Data
Aug. 1, 2023 (JP) 2023-125630

(51) Int. Cl. G01J 5/10; G01J 5/08; G01J 5/0806

(52) U.S. Cl. CPC G01J 5/10; G01J 5/0806; G01J 5/084; G01J 2005/106

(57) ABSTRACT

An infrared sensor element is provided that includes a pyroelectric element having a first main surface facing a first side in a thickness direction and a second main surface overlapping with the first main surface as viewed from the thickness direction and facing a second side in the thickness direction. The sensor element includes a first-side electrode on the first main surface; and a second-side electrode on the second main surface and overlapping with the first-side electrode as viewed from the thickness direction. As viewed from the thickness direction, the first-side electrode or the second-side electrode has a curved outer edge portion that is parabolic in shape.

### CROSS REFERENCE TO RELATED APPLICATIONS

This application is a continuation of PCT Application No. PCT/JP2024/020176, filed Jun. 3, 2024, which claims priority to Japanese Patent Application No. 2023-125630, filed Aug. 1, 2023, the entire contents of each of which are hereby incorporated by reference in their entireties.

### TECHNICAL FIELD

The present disclosure relates to an infrared sensor element, an infrared sensor including the infrared sensor element, and a position detection system including the infrared sensor.

### BACKGROUND

Infrared sensors using pyroelectric elements are known, for example, as described in Japanese Patent No. 4702366. Such infrared sensors can be used to detect the presence of a detection target, such as a human body.

In an infrared sensor using a pyroelectric element, for example, infrared rays emitted from the detection target are focused on the pyroelectric element through a lens, forming an image on the pyroelectric element. The portion of the pyroelectric element irradiated with the infrared rays is heated, changing the temperature of that portion. When the temperature changes, electric charges are generated by the pyroelectric effect on the surface of that portion of the pyroelectric element. This charge is output as an electric signal to the outside of the pyroelectric element. The detection target is detected based on the output electric signal.

For the temperature of the pyroelectric element to change, for example, the size and amount of light of an image focused on the pyroelectric element needs to change. In a case of detecting a moving detection target, for example, the size and amount of light of the image focused on a stationary pyroelectric element may change. On the other hand, to detect a stationary detection target, for example, the pyroelectric element is moved to change the image focused on the pyroelectric element.

Japanese Unexamined Patent Application Publication No. 8-184492 discloses an infrared sensor that changes the distance between a pyroelectric element and a detection target by vibrating the pyroelectric element in an optical axis direction of a light receiving surface of the pyroelectric element.

However, moving the pyroelectric element, as in the infrared sensor disclosed in Japanese Unexamined Patent Application Publication No. 8-184492, only enables detection of the presence or absence of the detection target within a field of view of the infrared sensor. In other words, additional information cannot be obtained, such as the direction in which the detection target is located relative to the infrared sensor.

To obtain such additional information, it is conceivable to provide high resolution by arraying a plurality of infrared sensors in a planar fashion. However, downsizing the arrayed sensor reduces the spacing between pyroelectric elements of adjacent two infrared sensors, potentially resulting in cross talk due to thermal conduction between the pyroelectric elements. In other words, there is a limit to downsizing the arrayed sensor. It is therefore difficult to achieve sufficient resolution by arranging the plurality of infrared sensors in a planar fashion.

### SUMMARY

In view of the foregoing, exemplary aspects of the present disclosure provide an infrared sensor element that can be downsized and is configured to detect the direction in which a detection target is located.

In an exemplary aspect, an infrared sensor element is provided that includes a pyroelectric element having a first main surface facing a first side in a thickness direction and a second main surface overlapping with the first main surface as viewed from the thickness direction and facing a second side in the thickness direction. The sensor element includes a first-side electrode on the first main surface; and an second-side electrode on the second main surface and that overlaps with the first-side electrode as viewed from the thickness direction. The first-side electrode or the second-side electrode has a curved outer edge portion that is parabolic in shape as viewed from the thickness direction.

The exemplary aspects of the present disclosure provide an infrared sensor element that can be downsized and is configured to detect the direction in which a detection target is located.

### BRIEF DESCRIPTION OF DRAWINGS

FIG. 1 is a functional block diagram of a position detection system according to a first exemplary embodiment of the present disclosure.

FIG. 2 is a schematic diagram illustrating infrared radiation from a detection target to an infrared sensor.

FIG. 3 is a schematic plan view of an infrared sensor element.

FIG. 4 is a schematic bottom view of the infrared sensor element.

FIG. 5 is a schematic cross-sectional view taken along line A-A in FIG. 3.

FIG. 6 is a schematic cross-sectional view taken along line B-B in FIG. 3, illustrating the infrared sensor element and a support.

FIG. 7 is a flowchart for explaining the operation of the position detection system.

FIG. 8 is a schematic plan view of the infrared sensor element for explaining calculation of an image center position.

FIG. 9 is a schematic cross-sectional view taken along line B-B in FIG. 3, illustrating a modification of the infrared sensor element and the support.

FIG. 10 is a schematic plan view of a modification of the infrared sensor element.

FIG. 11 is a schematic plan view of a modification of the infrared sensor element.

FIG. 12 is a schematic bottom view of the modification of the infrared sensor element.

FIG. 13 is a schematic cross-sectional view taken along line C-C in FIG. 11, illustrating the modification of the infrared sensor element and the support.

FIG. 14 is a schematic cross-sectional view taken along line D-D in FIG. 11.

FIG. 15 is a schematic cross-sectional view taken along line D-D in FIG. 11.

FIG. 16 is a schematic cross-sectional view taken along line C-C in FIG. 11, illustrating a modification of the infrared sensor element and the support.

FIG. 17 is a schematic diagram illustrating infrared radiation from a detection target to two infrared sensors.

### DETAILED DESCRIPTION OF EMBODIMENTS

An example of the present disclosure will be described below with reference to the accompanying drawings. Note that the following description is merely illustrative in nature and is not intended to limit the present disclosure, its applications, or its uses. It is noted that the drawings are schematic and the proportions of the dimensions and the like do not necessarily correspond to those in reality. In the following description, terms indicating specific directions or positions (for example, terms including “up”, “down”, “right”, “left”, “front”, and “rear”) are used for exemplary purposes. However, the use of the terms indicating specific directions or positions is intended to facilitate understanding of the present disclosure with reference to the drawings, and the meanings of these terms do not limit the technical scope of the present disclosure.

### First Exemplary Embodiment

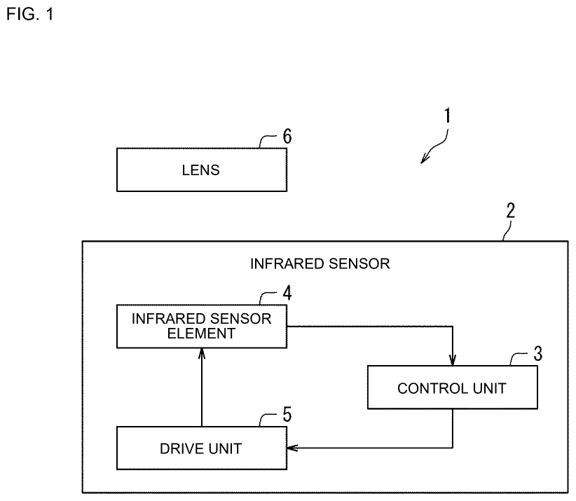

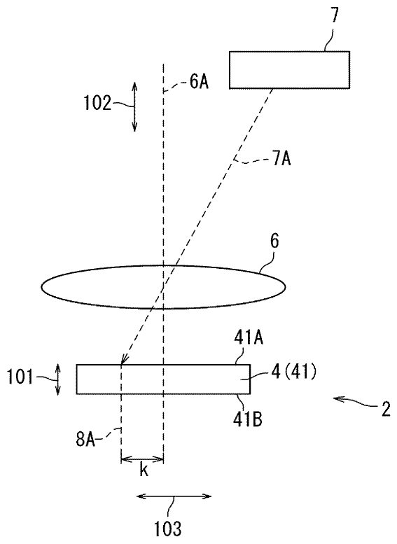

FIG. 1 is a functional block diagram of a position detection system according to a first embodiment of the present disclosure. FIG. 2 is a schematic diagram illustrating infrared radiation from a detection target to an infrared sensor.

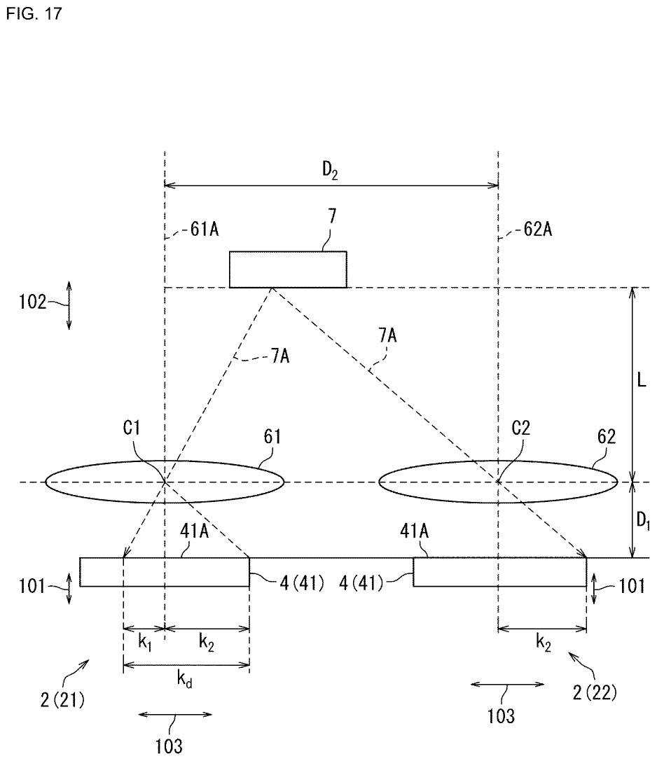

As illustrated in FIG. 1, a position detection system 1 includes an infrared sensor 2 and a lens 6. The infrared sensor 2 is configured to output an electric signal based on an infrared ray 7A emitted from a detection target 7 (see, e.g., FIG. 2), such as a person. Note that, in FIG. 2 and FIG. 17 to be described later, the infrared ray 7A is indicated by a dashed arrow for ease of explanation.

As illustrated in FIGS. 1 and 2, the infrared sensor 2 includes an infrared sensor element 4, a drive unit 5, and a control unit 3. As described later, the control unit 3 is configured to control the drive unit 5 and is configured to receive a signal from the infrared sensor element 4 to calculate an image center position k (see FIG. 2).

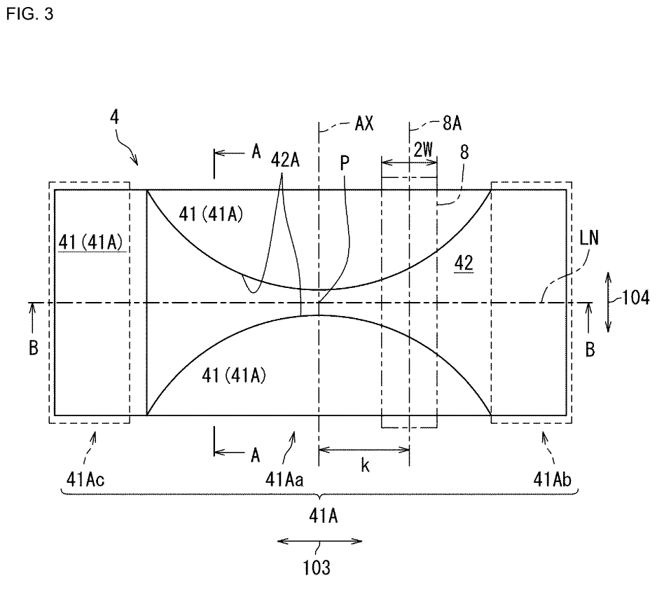

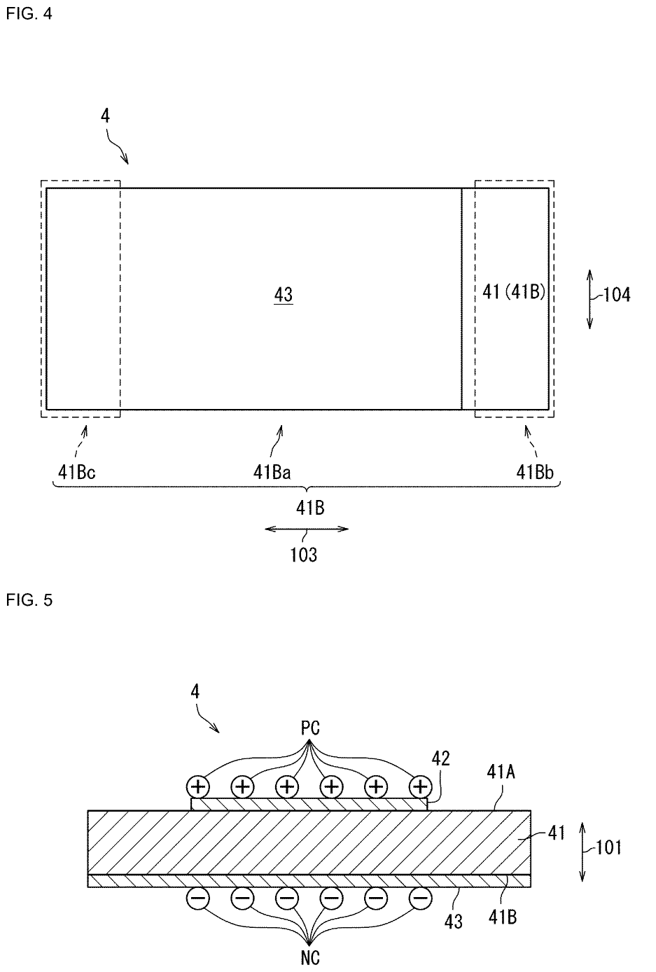

FIG. 3 is a schematic plan view of the infrared sensor element. FIG. 4 is a schematic bottom view of the infrared sensor element. FIG. 5 is a schematic cross-sectional view taken along line A-A in FIG. 3.

As illustrated in FIGS. 2 to 5, the infrared sensor element 4 includes a pyroelectric element 41 and a one-side electrode 42 (e.g., a first-side electrode) and an other-side electrode 43 (e.g., a second-side electrode) laminated on the pyroelectric element 41 in a thickness direction 101. Note that the one-side electrode 42 and the other-side electrode 43 are not illustrated in FIG. 2.

The pyroelectric element 41 has a rectangular parallelepiped shape in the exemplary aspect. As illustrated in FIGS. 3 and 4, the pyroelectric element 41 has a rectangular one main surface 41A (e.g., a first surface) and a rectangular other main surface 41B (e.g., a second surface). As illustrated in FIG. 5, the one main surface 41A faces one side (e.g., a first side or first direction) in the thickness direction 101. The other main surface 41B faces the other side (e.g., a second side or second direction) in the thickness direction 101. When viewed from the thickness direction 101, the one main surface 41A and the other main surface 41B overlap (e.g., in direction 101). It is noted that the pyroelectric element 41 is not limited to the rectangular parallelepiped shape. For example, the pyroelectric element 41 may have a cylindrical shape in an alternative exemplary aspect.

As illustrated in FIGS. 3 and 5, the one-side electrode 42 is laminated on the one main surface 41A of the pyroelectric element 41. In other words, the one-side electrode 42 is provided on the one main surface 41A. As illustrated in FIGS. 4 and 5, the other-side electrode 43 is laminated on the other main surface 41B of the pyroelectric element 41. In other words, the other-side electrode 43 is provided on the other main surface 41B.

As illustrated in FIG. 3, the one main surface 41A of the pyroelectric element 41 has a detection region 41Aa and two non-detection regions 41Ab and 41Ac. The two non-detection regions 41Ab and 41Ac are provided in both side portions of the one main surface 41A in an X-axis direction 103. The detection region 41Aa is provided between the two non-detection regions 41Ab and 41Ac in the X-axis direction 103. It is noted that the X-axis direction 103 is parallel to the one main surface 41A and is parallel to the longitudinal direction of the rectangular one main surface 41A.

As illustrated in FIG. 4, the other main surface 41B of the pyroelectric element 41 has a detection region 41Ba and two non-detection regions 41Bb and 41Bc. The two non-detection regions 41Bb and 41Bc are provided in both side portions of the other main surface 41B in the X-axis direction 103. The detection region 41Ba is provided between the two non-detection regions 41Bb and 41Bc in the X-axis direction 103.

The detection regions 41Aa and 41Ba illustrated in FIGS. 3 and 4 are regions where an image 8 is formed by radiation of the infrared ray 7A (see FIG. 2) from the detection target 7. The non-detection regions 41Ab, 41Ac, 41Bb, and 41Bc are regions used for electrical connection of the infrared sensor element 4 to the outside and for supporting the pyroelectric element 41.

In FIGS. 3 and 4, the non-detection regions 41Ab, 41Ac, 41Bb, and 41Bc are regions surrounded by dashed lines, and the detection regions 41Aa and 41Ba are regions excluding the regions surrounded by the dashed lines.

As illustrated in FIGS. 3 and 4, when viewed from the thickness direction 101, the detection region 41Aa of the one main surface 41A overlaps with the detection region 41Ba of the other main surface 41B. When viewed from the thickness direction 101, the non-detection region 41Ab of the one main surface 41A overlaps with the non-detection region 41Bb of the other main surface 41B. When viewed from the thickness direction 101, the non-detection region 41Ac of the one main surface 41A overlaps with the non-detection region 41Bc of the other main surface 41B.

In the configuration illustrated in FIGS. 3 and 4, the entire detection region 41Aa overlaps with the entire detection region 41Ba when viewed from the thickness direction 101 in an exemplary aspect, but the present disclosure is not limited to such a configuration. For example, only a portion of the detection region 41Aa may overlap with only a portion of the detection region 41Ba (i.e., not entirely overlapping) when viewed from the thickness direction 101.

In the configuration illustrated in FIGS. 3 and 4, the entire non-detection region 41Ab overlaps with the entire non-detection region 41Bb when viewed from the thickness direction 101, and the entire non-detection region 41Ac overlaps with the entire non-detection region 41Bc when viewed from the thickness direction 101, but the present disclosure is not limited to such a configuration. For example, the non-detection region 41Ab does not have to overlap with the non-detection region 41Bb when viewed from the thickness direction 101.

As illustrated in FIG. 3, the one-side electrode 42 is provided across the detection region 41Aa and the non-detection region 41Ab of the one main surface 41A.

As illustrated in FIG. 4, the other-side electrode 43 is provided across the detection region 41Ba and the non-detection region 41Bc of the other main surface 41B.

As illustrated in FIGS. 3 and 4, when viewed from the thickness direction 101, a portion of the one-side electrode 42 provided in the detection region 41Aa overlaps with a portion of the other-side electrode 43 provided in the detection region 41Ba.

When viewed from the thickness direction 101, a portion of the one-side electrode 42 provided in the non-detection region 41Ab does not overlap with a portion of the other-side electrode 43 provided in the non-detection region 41Bc. In other words, when viewed from the thickness direction 101, the non-detection region 41Ab of the one main surface 41A on which the one-side electrode 42 is provided is located in a position away from the non-detection region 41Bc of the other main surface 41B on which the other-side electrode 43 is provided.

When viewed from the thickness direction 101, the non-detection region of the one main surface 41A on which the one-side electrode 42 is provided may overlap with the non-detection region of the other main surface 41B on which the other-side electrode 43 is provided. For example, the one-side electrode 42 may be provided in the non-detection region 41Ac of the one main surface 41A, and the other-side electrode 43 may be provided in the non-detection region 41Bc of the other main surface 41B.

As illustrated in FIG. 3, when viewed from the thickness direction 101, the one-side electrode 42 has two curved outer edge portions 42A that are parabolic in shape. Each parabola of the two curved outer edge portions 42A shares a common axis AX that is parallel to a Y-axis direction 104. The parabolic shapes can generally be viewed as concave shapes as shown in FIG. 3, for example, Moreover, the Y-axis direction 104 is parallel to a short direction of the rectangular one main surface 41A. In other words, the Y-axis direction 104 is parallel to the one main surface 41A and orthogonal to the X-axis direction 103. In the first embodiment, the two curved outer edge portions 42A are line-symmetric with respect to a line LN that is orthogonal to the axis AX, in other words, parallel to the X-axis direction 103, so that the vertices of the two curved outer edge portions 42A are closest to each other. It is noted that the two curved outer edge portions 42A do not have to be line-symmetric with respect to each other in accordance with an exemplary aspect.

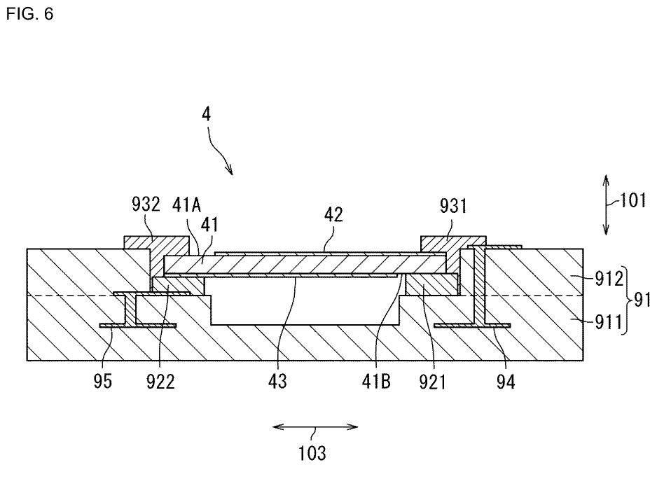

FIG. 6 is a schematic cross-sectional view taken along line B-B in FIG. 3, illustrating the infrared sensor element and a support.

As illustrated in FIG. 6, the infrared sensor element 4 is supported by a support 91. In the first embodiment, the support 91 can be made of low temperature co-fired ceramics (LTCC) and includes a first support portion 911 and a second support portion 912 laminated on the first support portion 911. It is noted that the boundary between the first support portion 911 and the second support portion 912 may be indistinguishable. This boundary is therefore indicated by a dashed line in FIG. 6. The support 91 may also be made of a material other than LTCC as would be appreciated to one skilled in the art.

In an exemplary aspect, conductive pastes 921 and 922 made of copper or the like are formed on the first support portion 911. The pyroelectric element 41 is attached onto the pastes 921 and 922 with the other main surface 41B facing the pastes 921 and 922. This configuration causes the other-side electrode 43 formed on the other main surface 41B to be in contact with the paste 922.

In an exemplary aspect, conductive pastes 931 and 932 made of copper or the like are formed on the second support portion 912. The paste 931 is in contact with the paste 921 and the one-side electrode 42. Moreover, the paste 932 is in contact with the paste 922.

Wirings 94 and 95 are formed on the surface and inside of the support 91. The wiring 94 is in contact with the paste 931. The wiring 95 is in contact with the paste 922. Although not illustrated in FIG. 6, the wirings 94 and 95 are electrically connected to the outside of the support 91 (e.g., the control unit 3 illustrated in FIG. 1 in the first embodiment).

The drive unit 5 illustrated in FIG. 1 drives the infrared sensor element 4. The drive unit 5 can be an actuator, such as a motor, for example. In the first embodiment, the drive unit 5 is a motor equipped with a coil and a rotor. The drive unit 5 is mechanically coupled to the infrared sensor element 4 or the support 91. As the rotor of the drive unit 5 rotates, the infrared sensor element 4 and the support 91 move along the X-axis direction 103 (see FIG. 2). In other words, the drive unit 5 moves the infrared sensor element 4 and the support 91 along the X-axis direction 103.

In the first embodiment, the drive unit 5 is sinusoidally driven by the control unit 3 (see FIG. 1). The rotational speed of the rotor changes with a sinusoidal voltage applied to the coil by the control unit 3. The movement speed of the infrared sensor element 4 changes with the rotational speed of the rotor.

As illustrated in FIG. 2, the lens 6 is provided so as to face the one main surface 41A of the pyroelectric element 41 in an optical axis direction 102. In the first embodiment, the optical axis direction 102 is parallel to the thickness direction 101 of the pyroelectric element 41. In the first embodiment, an optical axis 6A of the lens 6 passes through a position P (see FIG. 3) where the axis AX on the one main surface 41A intersects with the line LN. In the first embodiment, the one main surface 41A corresponds to a counter surface. It is noted that the lens 6 may also be provided so as to face the other main surface 41B of the pyroelectric element 41 in the optical axis direction 102 as would be appreciated to one skilled in the art. In this case, the other main surface 41B corresponds to the counter surface.

The lens 6 is configured to focus the infrared ray 7A emitted from the detection target 7 on the one main surface 41A of the pyroelectric element 41. In this case, the image 8 (see FIG. 3) formed on the one main surface 41A by the infrared ray passing through the lens 6 satisfies the following conditions. In other words, the lens 6 is positioned so that the image 8 satisfies the following conditions.

The first condition is that the image 8 is formed from one end to the other end of the one main surface 41A in the Y-axis direction 104, as illustrated in FIG. 3. The second condition is that the image 8 is formed to be shorter than the one main surface 41A (the detection region 41Aa of the one main surface 41A in the first embodiment) in the X-axis direction 103. In other words, the image 8 is formed in the region surrounded by the two-dot chain line in FIG. 3.

It is noted that the position of the image 8 (e.g., the region surrounded by the two-dot chain line in FIG. 3) in the X-axis direction 103 is one example. It should be appreciated the position of the image 8 in the X-axis direction 103 can vary depending on the relative position of the lens 6 with respect to the detection target 7. Thus, the position of the image 8 in the X-axis direction 103 can be moved to any position in the detection region 41Aa of the one main surface 41A by the drive unit 5 moving the infrared sensor element 4.

The positions of the lens 6 and the pyroelectric element 41 illustrated in FIG. 2 may be determined so that the image 8 satisfies the above conditions. Moreover, the lens 6 with different focal lengths in the X-axis direction 103 and the Y-axis direction 104 may be used so that the image 8 satisfies the above conditions. Furthermore, the lens 6 with variable aspect ratios in the X-axis direction 103 and the Y-axis direction 104 may be used so that the image 8 satisfies the above conditions.

According to the exemplary aspect, the temperature of the pyroelectric element 41 changes as the infrared ray 7A emitted from the detection target 7 enters the pyroelectric element. As illustrated in FIG. 2, the infrared ray 7A emitted from the detection target 7 is focused on the one main surface 41A of the pyroelectric element 41 by the lens 6. The temperature of the pyroelectric element 41 rises in the portion of the pyroelectric element 41 overlapping with the image 8 formed when viewed from the thickness direction 101. In response to this temperature change, surface charges are generated on the main surfaces (one main surface 41A and the other main surface 41B) of the pyroelectric element 41 by the pyroelectric effect. For example, as illustrated in FIG. 5, positive charges PC are generated on the one main surface 41A, and negative charges NC are generated on the other main surface 41B.

The surface charge generated on the one main surface 41A (for example, the positive charge PC illustrated in FIG. 5) is outputted as an electric signal from the one-side electrode 42 to the outside of the infrared sensor element 4 (e.g., the control unit 3 illustrated in FIG. 1 in the first embodiment) through the paste 931 and the wiring 94 (see FIG. 6). The surface charge generated on the other main surface 41B (for example, the negative charge NC illustrated in FIG. 5) is outputted as an electric signal from the other-side electrode 43 to the outside of the infrared sensor element 4 (e.g., the control unit 3 illustrated in FIG. 1 in the first embodiment) through the paste 922 and the wiring 95 (see FIG. 6).

The control unit 3 illustrated in FIG. 1 is electrically connected to the one-side electrode 42 of the infrared sensor element 4 through the wiring 94 and the paste 931 illustrated in FIG. 6. The control unit 3 illustrated in FIG. 1 is electrically connected to the other-side electrode 43 of the infrared sensor element 4 through the wiring 95 and the paste 922 illustrated in FIG. 6. As illustrated in FIG. 1, the control unit 3 is also electrically connected to the drive unit 5 through wiring or the like (not illustrated).

In an exemplary aspect, the control unit 3 can be an existing configuration, for example, a processor configured to implement predetermined functions in cooperation with software and/or wired logic where programs cannot be rewritten. The processor is, for example, a central processing unit (CPU) configured to read programs stored in a memory and execute various processing. The wired logic is, for example, an application specific integrated circuit (ASIC).

As described below, the control unit 3 is configured to control the drive of the drive unit 5 and to calculate the image center position k (see FIG. 2).

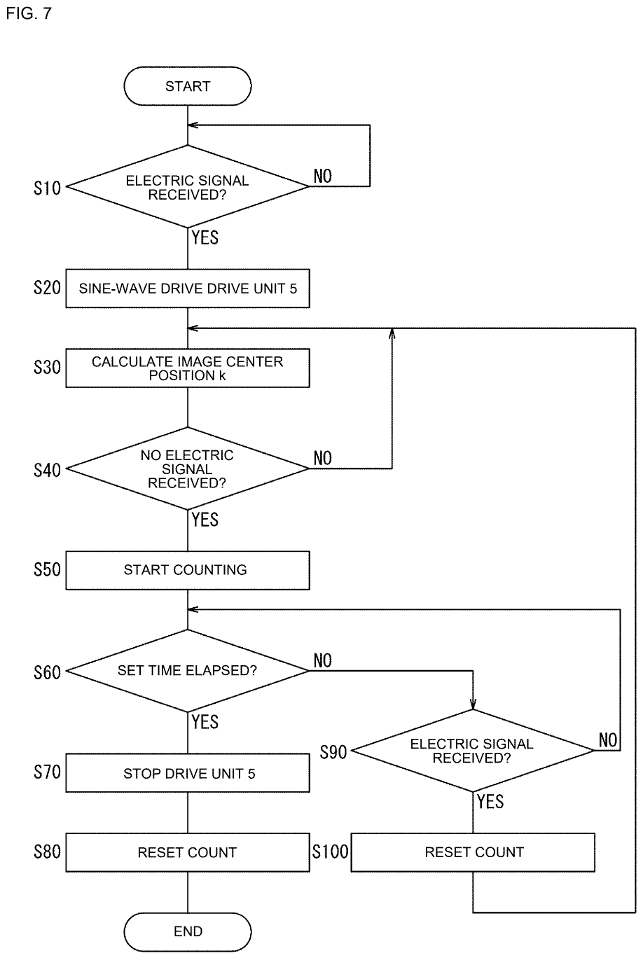

FIG. 7 is a flowchart for explaining an operation of the position detection system. A detection operation of the position detection system 1 will be described below with reference to FIGS. 2 and 7.

The position detection system 1 waits until the control unit 3 receives an electric signal (NO in S10). Here, receiving an electric signal refers, for example, to a voltage equal to or greater than a preset threshold being inputted to the control unit 3.

If there is an input voltage (YES in S10), the control unit 3 sinusoidally drives the drive unit 5. This will be described in detail below. As the infrared ray 7A from the detection target 7 enters the pyroelectric element 41, the pyroelectric element 41 is heated. This generates surface charges on the one main surface 41A and the other main surface 41B of the pyroelectric element 41. The generated surface charges are outputted as electric signals from the one-side electrode 42 and the other-side electrode 43 to the control unit 3. Upon receipt of the electric signal outputted from the pyroelectric element 41, the control unit 3 applies a sinusoidal voltage of a frequency f (Hz) to the coil of the drive unit 5. The drive unit 5 is thus sinusoidally driven at the frequency f (Hz). As the drive unit 5 is sinusoidally driven, the infrared sensor element 4 and the support 91 move along the X-axis direction 103 while accelerating or decelerating in accordance with the sinusoidal voltage.

In this event, the value (for example, effective value) of the sinusoidal voltage applied to the coil of the drive unit 5 by the control unit 3 is determined so that the image 8 (see FIG. 3) is not positioned outside the detection region 41Aa of the one main surface 41A when viewed from the thickness direction 101. In other words, the value of the sinusoidal voltage to the coil of the drive unit 5 applied by the control unit 3 is determined so that the image 8 does not overlap with the non-detection regions 41Ab and 41Ac of the one main surface 41A when viewed from the thickness direction 101. That is, the value of the sinusoidal voltage to the coil of the drive unit 5 applied by the control unit 3 is determined so that the movement amount of the image 8 relative to the one main surface 41A is not too large.

Here, the larger the amplitude (α in Formula (1) described below) of the movement of the infrared sensor element 4 along the X-axis direction 103 according to the sinusoidal voltage, the better. In other words, the larger the movement of the infrared sensor element 4 along the X-axis direction 103, the better. To this end, it is desirable that the length of the image 8 in the X-axis direction 103 (e.g., twice the value of w in Formula (1) described below; see FIG. 3) be sufficiently shorter than the detection region 41Aa of the one main surface 41A in the X-axis direction 103.

As the infrared sensor element 4 moves, the position of the image 8 formed on the one main surface 41A of the pyroelectric element 41 of the infrared sensor element 4 changes. This changes the overlapping area between the image 8 and the one-side electrode 42 when viewed from the thickness direction 101, and therefore changes the electric signals outputted from the one-side electrode 42 and the other-side electrode 43 to the control unit 3. Specifically, if the overlapping area increases, the values of the electric signals outputted from the one-side electrode 42 and the other-side electrode 43 to the control unit 3 increase. On the other hand, if the overlapping area decreases, the values (for example, effective values) of the electric signals outputted from the one-side electrode 42 and the other-side electrode 43 to the control unit 3 decrease. The control unit 3 is then configured to calculate the image center position k (see FIG. 2) based on these changing electric signals (S30). The calculation of the image center position k will be described in detail later.

In the first embodiment, the control unit 3 is configured to calculate the image center position k based on the electric signals outputted from the one-side electrode 42 and the other-side electrode 43. However, the image center position k may also be calculated based on the electric signal outputted from one of the one-side electrode 42 and the other-side electrode 43. For example, the control unit 3 may calculate the image center position k based on an electric signal from the electrode (e.g., the one-side electrode 42 in the first embodiment) whose overlapping area with the image 8 changes as the infrared sensor element 4 moves. In a configuration in which the other-side electrode 43 has a curved outer edge portion, the control unit 3 may calculate the image center position k based on the electric signal from the other-side electrode 43.

After calculating the image center position k, the control unit 3 can then be configured to determine whether to stop the drive unit 5 (S40 to S90) as described in detail below.

The control unit 3 repeats the calculation of the image center position k until no more electric signals are received from the infrared sensor element 4 (NO in S40, S30). Here, the phrase “no electric signal received” can indicate, for example, that the voltage inputted to the control unit 3 is below the preset threshold.

When no more electric signals are received from the infrared sensor element 4 (YES in S40), the control unit 3 starts counting time (S50). This time counting is performed, for example, by a counter built into the control unit 3.

When the count by the counter reaches or exceeds a preset time, that is, when the preset time elapses after the control unit 3 receives no more electric signals from the infrared sensor element 4 (YES in S60), the control unit 3 stops applying the sinusoidal voltage to the coil of the drive unit 5. As a result, the drive unit 5 is stopped (S70). The control unit 3 then resets the count (S80) and ends the detection operation.

On the other hand, if the control unit 3 receives the electric signal from the infrared sensor element 4 (YES in S90) when the count by the counter is less than the set time (NO in S60), the control unit 3 resets the counter (S100). The control unit 3 then resumes the calculation of the image center position k based on the received electric signal (S30).

In the flowchart of FIG. 7, the position detection system 1 starts the detection operation triggered by the control unit 3 receiving an electric signal, and stops the detection operation when the control unit 3 receives no more electric signals for the set time. However, the detection operation of the position detection system 1 is not limited thereto. For example, the position detection system 1 may perform the detection operation continuously in an alternative aspect. Alternatively, for example, the position detection system 1 may perform the detection operation at preset intervals.

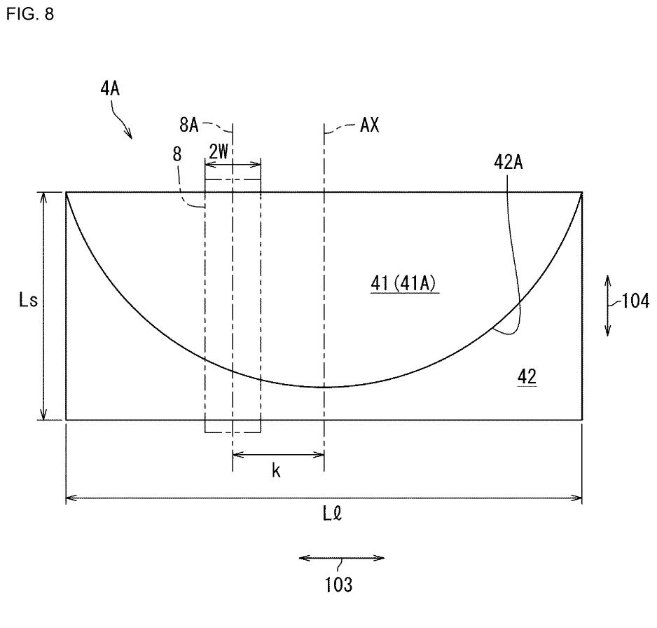

FIG. 8 is a schematic plan view of an infrared sensor element for explaining the calculation of the image center position. The calculation of the image center position k by the control unit 3 will be described below with reference to FIG. 8. An infrared sensor element 4A illustrated in FIG. 8 has one parabolic curved outer edge portion 42A. In this point, the infrared sensor element 4A is different from the infrared sensor element 4 (see FIG. 3) having two parabolic curved outer edge portions 42A.

The image center position k of the image 8 formed on the one main surface 41A by the infrared ray 7A emitted from the detection target 7 through the lens 6 is the position of the center of the image 8 relative to the axis AX of the parabola in the X-axis direction 103. In other words, the image center position k is the distance in the X-axis direction 103 between a center position 8A of the image 8 and the axis AX of the parabolic curved outer edge portion 42A.

The overlapping portion (indicated by hatching in FIG. 8) between the one-side electrode 42 and the image 8 when viewed from the thickness direction 101 moves along the X-axis direction 103 as the pyroelectric element 41 moves. This changes an area S(t) of that portion. The area S(t) is expressed by Formula (1) below.

$$[ Math 1 ]$$

$$S ( t ) = 2 β w {( α sin ( θ t ) + k )}^{2} + \frac{2}{3} β {w}^{3} \qquad ( 1 )$$

The meanings of the symbols in Formula (1) are as follows: t is time, α is the amplitude of the infrared sensor element 4 when the infrared sensor element 4 moves according to the applied sinusoidal voltage, β is the coefficient of the parabola, which represents the shape of the curved outer edge portion, when the function formula of the parabola is y=βx²+γ. In this parabola, x is a variable indicating the position in the X-axis direction 103, y is a variable indicating the position in the Y-axis direction 104, and γ is the intercept. Moreover, w represents half the length of the image 8 in the X-axis direction 103, k is the image center position, Θ=2πf, and f is the frequency of the sinusoidal voltage.

In general, it may be difficult to obtain the exact value of w, which represents half the length of the image 8 in the X-axis direction 103, but this is not a problem. This is because the value is canceled out by simplifying the numerator and denominator in Formula (6).

The infrared sensor element 4A illustrated in FIG. 8 has one parabolic curved outer edge portion 42A. On the other hand, the infrared sensor element 4 illustrated in FIG. 3 has two parabolic curved outer edge portions 42A. Therefore, the area S(t) of the infrared sensor element 4 is expressed, for example, as twice the value of Formula (1).

It is noted that an example of specific values for the infrared sensor element 4A illustrated in FIG. 8 is as follows. The long side of the pyroelectric element 41 illustrated in FIG. 8 has a length L₁ of 5 mm and the short side thereof has a length Lₛ of 2 mm. The coefficient β of the parabolic function formula y=βx²+γ on the one main surface 41A of the pyroelectric element 41 is 0.21 mm, and the intercept of the function formula is 0.1 mm. The amount of infrared rays reaching the pyroelectric element 41 from the detection target 7 is 0.4386 W/m². In this case, the length in the X-axis direction 103 of the image 8 formed on the one main surface 41A of the pyroelectric element 41, that is, 2w is 0.5 mm. Furthermore, the frequency of the sinusoidal voltage is 10 Hz, and the amplitude a of the infrared sensor element 4, which moves according to the sinusoidal voltage, is 0.2 mm.

Formula (2) is obtained by developing Formula (1).

$$[ Math 2 ]$$

$$S ( t ) = w {α}^{2} β cos ( 2 θ t ) + 4 wk α β sin ( θ t ) + w {α}^{2} + 2 {w}^{2} {k}^{2} + \frac{2}{3} {w}^{3} \qquad ( 2 )$$

A change in area S(t) over time is expressed by Formula (3) by differentiating Formula (2).

$$[ Math 3 ]$$

$$\frac{dS ( t )}{dt} = 4 wk α β θ cos ( θ t ) + 2 {wα}^{2} βθ sin ( 2 θ t ) \qquad ( 3 )$$

Focusing on the spectrum, the product of the change in area S(t) over time and the electrothermal characteristics of the pyroelectric element 41 bears a proportionate relationship to the output voltage of the infrared sensor element 4. This relationship is expressed by Formula (4) and Formula (5) below.

$$[ Math 4 ]$$

$${V}_{F} ∝ 4 wk α θ H ( θ ) \qquad ( 4 )$$

$$[ Math 5 ]$$

$${V}_{S} ∝ 2 w {α}^{2} θ H ( 2 θ ) \qquad ( 5 )$$

The meanings of the symbols in Formulas (4) and (5) are as follows. H(θ) represents the electrothermal characteristics of the pyroelectric element 41 at the frequency f. H(2θ) represents the electrothermal characteristics of the pyroelectric element 41 at a frequency twice the frequency f. V_{F} represents a voltage component of the electric signal outputted from the infrared sensor element 4 to the control unit 3 at the frequency f. V_{S} represents a voltage component of the electric signal outputted from the infrared sensor element 4 to the control unit 3 at the frequency twice the frequency f.

Formula (6) below is obtained by dividing the left and right sides of Formulas (4) and (5).

$$[ Math 6 ]$$

$$\frac{{V}_{F}}{{V}_{S}} = \frac{4 wk α β θ H ( θ )}{2 w {α}^{2} β θ H ( 2 θ )} = \frac{2 kH ( θ )}{α H ( 2 θ )} \qquad ( 6 )$$

From Formula (6), the image center position k is expressed by Formula (7) below.

$$[ Math 7 ]$$

$$k = \frac{α}{2} \frac{{V}_{F}}{{V}_{S}} \frac{H ( 2 θ )}{H ( θ )} \qquad ( 7 )$$

In Formula (7), α is the amplitude of the infrared sensor element 4 when the infrared sensor element 4 moves according to the applied sinusoidal voltage, as mentioned above, and is known. The electrothermal characteristics H(θ) and H(2θ) are known values, since they depend on the material and shape of the pyroelectric element 41, which are determined by design, and the drive frequency controlled by the control unit 3. The electrothermal characteristics H(θ) and H(2θ) do not depend on the width of the image 8 or the amount of infrared rays, which are determined by the detection target 7. For example, when the pyroelectric element 41 is made of ceramic, H(2θ)/H(θ)=1/2 can be calculated in Formula (7).

The control unit 3 is configured to calculate the image center position k using Formula (7).

The control unit 3 determines as follows, for example, whether the image center position k is located to the right or left of the axis AX.

For example, the infrared sensor element 4 may further include an optical sensor for detecting the position of the image 8. In this case, the control unit 3 may determine whether the image center position k is located to the right or left of the axis AX of the parabola at the center of the image 8, based on a signal outputted from the sensor.

Alternatively, for example, a motor that rotates in a direction corresponding to the positive or negative voltage applied by the control unit 3 may be used as the drive unit 5.

For example, the motor rotates clockwise when the voltage applied by the control unit 3 is positive, and rotates counterclockwise when the voltage applied by the control unit 3 is negative. When such a motor is used, the control unit 3 can identify the movement direction of the infrared sensor element 4, depending on whether the voltage value of the sinusoidal voltage applied to the coil of the drive unit 5 is positive or negative. For example, the control unit 3 determines that the infrared sensor element 4 is moving leftward when the applied voltage value is positive, and determines that the infrared sensor element 4 is moving rightward when the applied voltage value is negative. In other words, the control unit 3 determines that the image 8 is moving rightward relative to the pyroelectric element 41 when the applied voltage value is positive, and determines that the image 8 is moving leftward relative to the pyroelectric element 41 when the applied voltage value is negative.

As described above, if the overlapping area between the image 8 and the one-side electrode 42 as viewed from the thickness direction 101 increases, the value of the electric signal outputted from the infrared sensor element 4 to the control unit 3 increases. If the overlapping area decreases, the value of the electric signal decreases.

From the above configuration and operation, the control unit 3 can be configured to determine as follows whether the image center position k is located to the right or left of the axis AX of the parabola at the center of the image 8.

If the value of the electric signal from the infrared sensor element 4 to the control unit 3 increases when the sinusoidal voltage applied to the coil of the drive unit 5 by the control unit 3 is positive, the control unit 3 determines that the image 8 is located to the right of the axis AX, in other words, that the detection target 7 is located to the left of the axis AX.

On the other hand, if the value of the electric signal from the infrared sensor element 4 to the control unit 3 decreases when the sinusoidal voltage applied to the coil of the drive unit 5 by the control unit 3 is positive, the control unit 3 determines that the image 8 is located to the left of the axis AX, in other words, that the detection target 7 is located to the right of the axis AX.

Furthermore, if the value of the electric signal from the infrared sensor element 4 to the control unit 3 increases when the sinusoidal voltage applied to the coil of the drive unit 5 by the control unit 3 is negative, the control unit 3 determines that the image 8 is located to the left of the axis AX, in other words, that the detection target 7 is located to the right of the axis AX.

On the other hand, if the value of the electric signal from the infrared sensor element 4 to the control unit 3 decreases when the sinusoidal voltage applied to the coil of the drive unit 5 by the control unit 3 is negative, the control unit 3 determines that the image 8 is located to the right of the axis AX, in other words, that the detection target 7 is located to the left of the axis AX.

In the first embodiment, when the infrared ray 7A is radiated from the detection target 7 toward the pyroelectric element 41, the irradiated portion of the pyroelectric element 41 irradiated with the infrared ray 7A is heated. The irradiated portion of the pyroelectric element 41 is a portion of the pyroelectric element 41 extending in the light radiation direction from the region of the pyroelectric element 41 where the image 8 is formed on the one main surface 41A. In this case, electric charges are generated on the surface of the irradiated portion of the pyroelectric element 41, that is, the overlapping portion with the one-side electrode 42 and the other-side electrode 43 as viewed from the thickness direction 101. When one of the pyroelectric element 41 and the detection target 7 moves relative to the other, the position of the overlapping portion of the pyroelectric element 41 changes. According to the first embodiment, the one-side electrode 42 has the curved outer edge portion 42A that is parabolic in shape. Therefore, when the position of the overlapping portion changes due to the relative movement, the area change rate of the overlapping portion as viewed from the thickness direction 101 corresponds to the parabolic shape. The direction in which the detection target 7 is located relative to the infrared sensor element 4 can be calculated by using such characteristics of the area change rate.

As described above, in the first embodiment, the direction in which the detection target 7 is located relative to the infrared sensor element 4 can be calculated using a single infrared sensor element 4. This configuration enables the infrared sensor element 4 to be downsized.

According to the first embodiment, an electric signal based on electric charges generated on the one main surface 41A side is extracted from the one-side electrode 42 provided in the non-detection region 41Ab included in the one main surface 41A. An electric signal based on electric charges generated on the other main surface 41B side is extracted from the other-side electrode 43 provided in the non-detection region 41Bc included in the other main surface 41B. In other words, the two electric signals are extracted from different surfaces. Therefore, compared to a configuration in which the two electric signals are extracted from the same surface, the possibility of short-circuiting between the two electrodes (e.g., one-side electrode 42 and the other-side electrode 43) corresponding to the two electric signals, respectively, can be reduced.

According to the first embodiment, when viewed from the thickness direction 101, the non-detection region 41Ab of the one main surface 41A where the one-side electrode 42 is provided is located in a different position from the non-detection region 41Bc of the other main surface 41B where the other-side electrode 43 is provided. In other words, the two electric signals are extracted from different positions when viewed from the thickness direction 101. Therefore, compared to a configuration in which the two electric signals are extracted from the same position when viewed from the thickness direction 101, the possibility of short-circuiting between the two electrodes (e.g., one-side electrode 42 and the other-side electrode 43) corresponding to the two electric signals, respectively, can be reduced.

According to the first embodiment, the lens 6 is provided so that the image 8 formed on the one main surface 41A is formed from one end to the other end of the one main surface 41A in the Y-axis direction 104. Therefore, the curved outer edge portion 42A can be contained within the range of the image 8 in the Y-axis direction 104.

According to the first embodiment, the lens 6 is provided so that the image 8 formed on the one main surface 41A is formed to be shorter than the one main surface 41A (more specifically, the detection region 41Aa of the one main surface 41A) in the X-axis direction 103. This configuration allows the image 8 to be formed within the one main surface 41A in the X-axis direction 103. Furthermore, by limiting the movement distance of the pyroelectric element 41 to within the difference between the length of the one main surface 41A in the X-axis direction 103 and the length of the image 8 formed on the one main surface 41A in the X-axis direction 103, the image 8 moving along the X-axis direction 103 can be avoided from being positioned outside the one main surface 41A.

According to the first embodiment, the pyroelectric element 41 is moved by the drive unit 5. This configuration enables the position of the image 8 formed on the one main surface 41A of the pyroelectric element 41 to be changed. The detection target 7 can be detected based on the change in the position of the image 8.

According to the first embodiment, the pyroelectric element 41 moves along the X-axis direction 103. That is, the pyroelectric element 41 moves so as to intersect with a parabola that defines the curved outer edge portion 42A and has the axis AX parallel to the Y-axis direction 104. Therefore, the area change rate of the region where electric charges are generated as viewed from the thickness direction 101 when one of the pyroelectric element 41 and the detection target 7 moves relative to the other can be set to correspond to the parabolic shape.

As described above, according to the first embodiment, the curved outer edge portion 42A has a parabolic shape having the axis AX parallel to the Y-axis direction 104, and the pyroelectric element 41 moves along the X-axis direction 103 based on sinusoidal drive. As a result, a plurality of voltage output components can be obtained for the frequency of the movement based on the sinusoidal drive of the pyroelectric element 41, from the change in area of the overlapping portions with the one-side electrode 42 and the other-side electrode 43 as viewed from the thickness direction 101 within the irradiated portion of the pyroelectric element 41 irradiated with the infrared ray. The image center position k can be calculated from these plurality of voltage output components.

### <Modifications>

In the first exemplary embodiment, the description is given of the example where the one main surface 41A of the pyroelectric element 41 has the detection region 41Aa and the two non-detection regions 41Ab and 41Ac, and the other main surface 41B of the pyroelectric element 41 has the detection region 41Ba and the two non-detection regions 41Bb and 41Bc. However, it is noted that the number of non-detection regions of each of the one main surface 41A and the other main surface 41B is not limited to two. Furthermore, each of the one main surface 41A and the other main surface 41B does not have to have non-detection regions. In other words, each of the one main surface 41A and the other main surface 41B may have only the detection region.

In the first embodiment, the description is given of the configuration in which the control unit 3 is electrically connected to the one-side electrode 42 through the wiring 94 and the paste 931, and to the other-side electrode 43 through the wiring 95 and the paste 922. However, the control unit 3 may be electrically connected to the one-side electrode 42 and the other-side electrode 43 by other configurations.

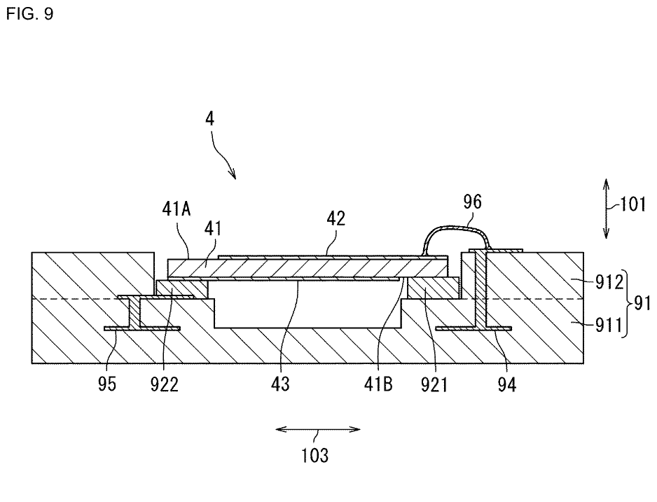

For example, the control unit 3 may be electrically connected to the one-side electrode 42 and the other-side electrode 43 by wire bonding. FIG. 9 is a schematic cross-sectional view taken along line B-B in FIG. 3, illustrating a modification of the infrared sensor element and the support. In the following description of the configuration illustrated in FIG. 9, the same components as those in the configuration illustrated in FIG. 6 will be denoted by the same reference numerals, and description thereof will be basically omitted. In FIG. 9, the one-side electrode 42 of the infrared sensor element 4 is electrically connected to the wiring 94 through a wire 96 rather than the paste 931. As a result, the one-side electrode 42 is electrically connected to the control unit 3 through the wire 96 and the wiring 94.

In the first embodiment, the description is given of the example where the infrared sensor 2 includes the drive unit 5, and the drive unit 5 moves the infrared sensor element 4 to change the position of the image 8, thereby detecting the position of the detection target 7. However, if the detection target 7 is moved, the image 8 moves relative to the infrared sensor element 4, even if the infrared sensor element 4 is stationary, thus making it possible to detect the detection target 7. In other words, if the detection target 7 is moved, the detection target 7 can be detected even if the infrared sensor 2 does not include the drive unit 5.

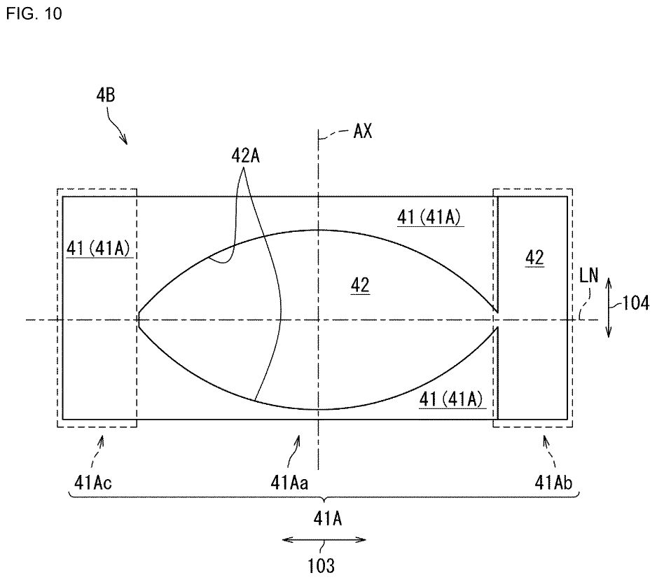

It is also noted that the shapes of the one-side electrode 42 and the other-side electrode 43 are not limited to those illustrated in FIG. 3. For example, the one-side electrode 42 and the other-side electrode 43 may have the shape illustrated in FIG. 10. FIG. 10 is a schematic plan view of a modification of the infrared sensor element. In the following description of an infrared sensor element 4B illustrated in FIG. 10, the same components as those of the infrared sensor element 4 illustrated in FIG. 3 will be denoted by the same reference numerals, and description thereof will be basically omitted, but will be given as needed.

A one-side electrode 42 of the infrared sensor element 4B illustrated in FIG. 10 has two curved outer edge portions 42A that are symmetric with respect to a line LN, so that their vertices are furthest apart. This is different from the one-side electrode 42 illustrated in FIG. 3.

In the first embodiment, the description is given of the example where the one-side electrode 42 has the two curved outer edge portions 42A. However, the number of the curved outer edge portions 42A of the one-side electrode 42 is not limited to two.

In the first embodiment, the description is given of the example where the one-side electrode 42 has the curved outer edge portions 42A. However, the other-side electrode 43 may have curved outer edge portions. Both the one-side electrode 42 and the other-side electrode 43 may have curved outer edge portions. In this case, it is desirable that the curved outer edge portions of the one-side electrode 42 and the other-side electrode 43 overlap each other when viewed from the thickness direction 101.

In the first embodiment, the one-side electrode 42 is provided in the non-detection region 41Ab of the one main surface 41A, and the other-side electrode 43 is provided in the non-detection region 41Bc of the other main surface 41B. In this case, electric signals are outputted to the outside from both the one main surface 41A and the other main surface 41B. Therefore, as illustrated in FIG. 6, the pyroelectric element 41 is supported so as to be sandwiched from both sides in the thickness direction 101 by the support 91.

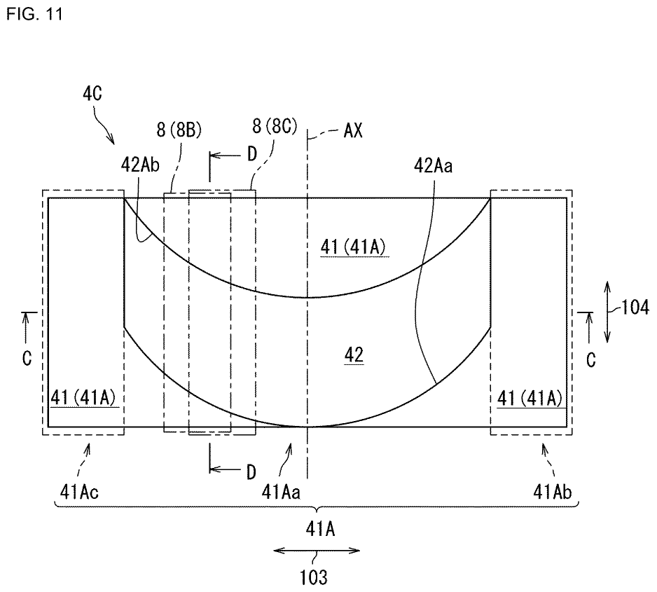

However, an electric signal may also be outputted to the outside from only one of the one main surface 41A and the other main surface 41B. In this case, the pyroelectric element 41 can be supported from only one side in the thickness direction 101 by the support 91. This configuration will be described below with reference to FIGS. 11 to 15. In the following description of an infrared sensor element 4C illustrated in FIGS. 11 to 15, the same components as those of the infrared sensor element 4 illustrated in FIGS. 3 to 6 will be denoted by the same reference numerals, and description thereof will be basically omitted, but will be given as needed.

FIG. 11 is a schematic plan view of a modification of the infrared sensor element. FIG. 12 is a schematic bottom view of the modification of the infrared sensor element.

As illustrated in FIG. 11, a one-side electrode 42 is provided in a detection region 41Aa of a one main surface 41A, but is not provided in non-detection regions 41Ab and 41Ac.

The one-side electrode 42 has two curved outer edge portions 42Aa and 42Ab that are parabolic in shape. When viewed from the thickness direction 101, the two curved outer edge portions 42Aa and 42Ab overlap with a detection region 41Ba of the other main surface 41B, but do not overlap with non-detection regions 41Bb and 41Bc of the other main surface 41B. Moreover, the parabolas of the two curved outer edge portions 42Aa and 42Ab share a common axis AX. The two curved outer edge portions 42Aa and 42Ab are parallel to each other. The curved outer edge portion 42Aa is an example of a first curved outer edge portion. The curved outer edge portion 42Ab is an example of a second curved outer edge portion.

As illustrated in FIG. 12, an other-side electrode 43 has a first electrode 431 and a second electrode 432. The first electrode 431 and the second electrode 432 are separated from each other. In other words, the first electrode 431 and the second electrode 432 are electrically insulated from each other by a space therebetween.

The first electrode 431 is provided across part of the detection region 41Ba of the other main surface 41B and the non-detection region 41Bb of the other main surface 41B. In the infrared sensor element 4C, the non-detection region 41Bb of the other main surface 41B is an example of a first non-detection region. When viewed from the thickness direction 101, the first electrode 431 overlaps with a portion of the one-side electrode 42 having the curved outer edge portion 42Aa.

The second electrode 432 is provided across part of the detection region 41Ba of the other main surface 41B (a portion where the first electrode 431 is not provided) and the non-detection region 41Bc of the other main surface 41B. In the infrared sensor element 4C, the non-detection region 41Bc of the other main surface 41B is an example of a second non-detection region. When viewed from the thickness direction 101, the second electrode 432 overlaps with a portion of the one-side electrode 42 having the curved outer edge portion 42Ab.

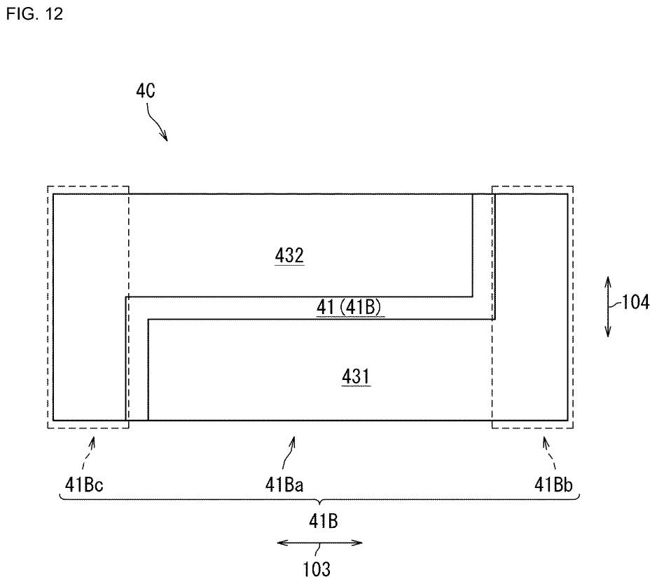

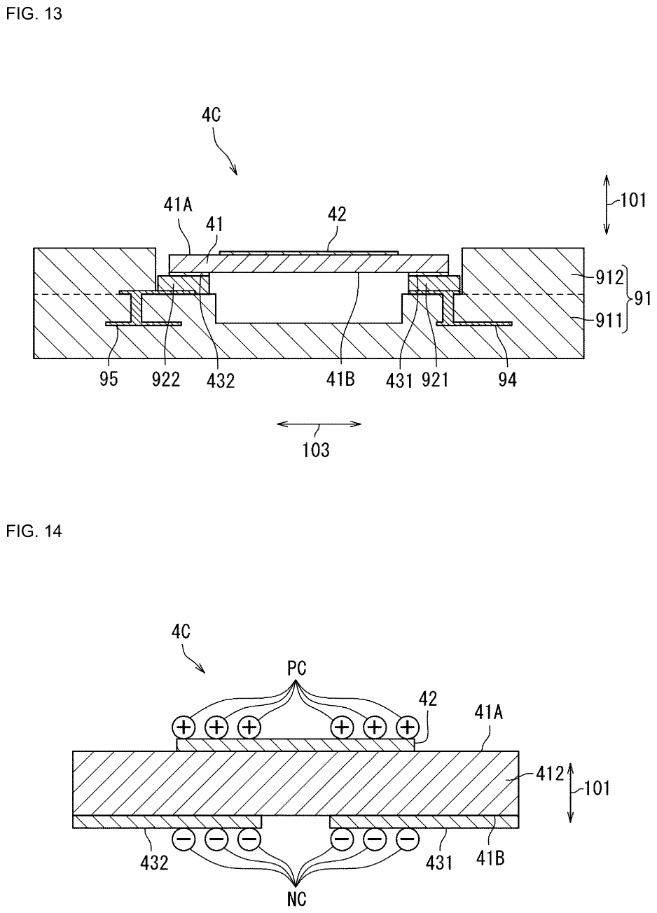

FIG. 13 is a schematic cross-sectional view taken along line C-C in FIG. 11, illustrating the modification of the infrared sensor element and the support. In the following description of the configuration illustrated in FIG. 13, the same components as those in the configuration illustrated in FIG. 6 will be denoted by the same reference numerals, and description thereof will be basically omitted.

As illustrated in FIG. 13, the first electrode 431 of the infrared sensor element 4C is in contact with the paste 921, and the second electrode 432 of the infrared sensor element 4C is in contact with the paste 922. In the configuration illustrated in FIG. 13, the pastes 931 and 932 are not provided. The wiring 94 is in contact with the paste 921. Moreover, the wiring 95 is in contact with the paste 922. As a result, the first electrode 431 is electrically connected to the control unit 3 through the paste 921 and the wiring 94, and the second electrode 432 is electrically connected to the control unit 3 through the paste 922 and the wiring 95.

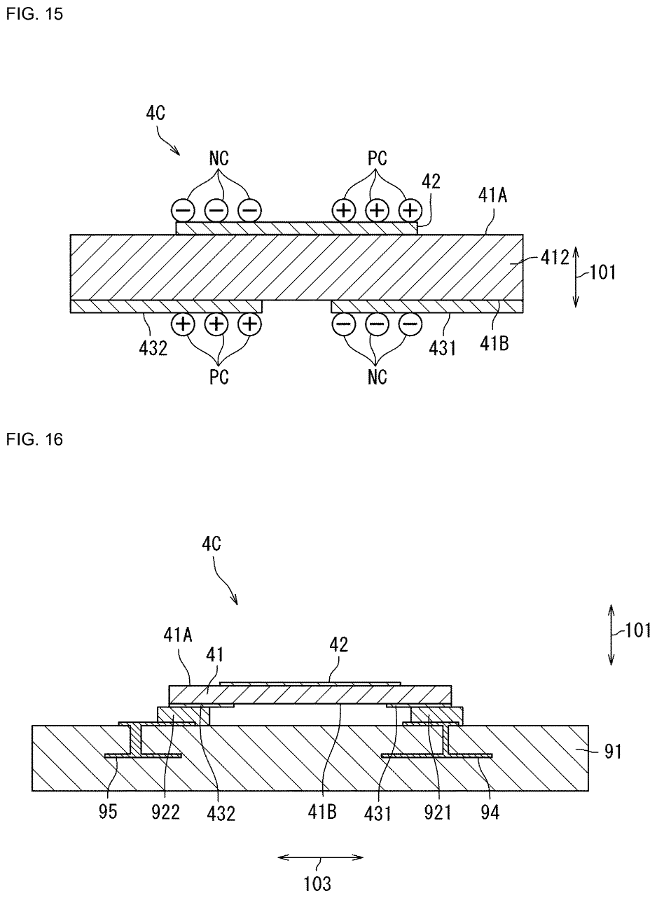

With reference to FIGS. 14 and 15, description will be given below of the generation of surface charges in the infrared sensor element 4C. FIGS. 14 and 15 are schematic cross-sectional views taken along line D-D in FIG. 11.

When an infrared ray emitted from the detection target 7 (see FIG. 2) forms an image 8 in a region including the D-D cross section of FIG. 11, surface charges are generated by the pyroelectric effect on the main surfaces (e.g., one main surface 41A and the other main surface 41B) of the pyroelectric element 41, as illustrated in FIG. 14. For example, positive charges PC are generated on the one main surface 41A, and negative charges NC are generated on the other main surface 41B.

The surface charges generated on the one main surface 41A (for example, the positive charges PC illustrated in FIG. 14) are not outputted to the outside of the infrared sensor element 4C. The surface charges generated on the other main surface 41B can be outputted to the outside of the infrared sensor element 4C. However, in such a state where the positive charges PC are generated on the one main surface 41A and the negative charges NC are generated on the other main surface 41B as illustrated in FIG. 14, no potential difference occurs between the one main surface 41A and the other main surface 41B. Therefore, the surface charges generated on the other main surface 41B are not outputted to the outside of the infrared sensor element 4C.

However, the surface charges generated on the other main surface 41B are outputted to the outside of the infrared sensor element 4C as the image 8 formed in the detection region 41Aa of the one main surface 41A moves. This will be described in detail below. For example, as illustrated in FIG. 11, when the image 8 formed in the detection region 41Aa moves from a position indicated by reference numeral 8B to a position indicated by reference numeral 8C, the area of the overlapping portion between the image 8 and the one-side electrode 42 decreases, as viewed from the thickness direction 101, in the upper part of FIG. 11. On the other hand, when the image 8 formed in the detection region 41Aa moves from the position indicated by reference numeral 8B to the position indicated by reference numeral 8C, the area of the overlapping portion between the image 8 and the one-side electrode 42 increases, as viewed from the thickness direction 101, in the lower part of FIG. 11. In the upper part of FIG. 11, the second electrode 432 (see FIG. 12) overlaps with the one-side electrode 42 when viewed from the thickness direction 101. In the lower part of FIG. 11, the first electrode 431 (see FIG. 12) overlaps with the one-side electrode 42 when viewed from the thickness direction 101.

Due to the increase or decrease in area caused by the movement of the image 8, different electric charges are generated in the portions where the area is increased and decreased. For example, as illustrated in FIG. 15, in the portions where the area is decreased, negative charges NC are generated on the one main surface 41A and positive charges PC are generated on the other main surface 41B. In the portions where the area is increased, on the other hand, positive charges PC are generated on the one main surface 41A and negative charges NC are generated on the other main surface 41B. This causes a potential difference of opposite polarity between the portions where the area is increased and decreased. Therefore, the negative charge NC generated in the portion where the area is increased is outputted as an electric signal from the first electrode 431 to the outside of the infrared sensor element 4C (e.g., control unit 3) through the paste 921. On the other hand, the positive charge PC generated in the portion where the area is decreased is outputted as an electric signal from the second electrode 432 to the outside of the infrared sensor element 4C (e.g., control unit 3) through the paste 922.

Accordingly, in the infrared sensor element 4C, the surface charges generated on the other main surface 41B are outputted to the outside, while the surface charges generated on the one main surface 41A are not outputted to the outside. In this respect, the infrared sensor element 4C is different from the infrared sensor element 4, in which the surface charges generated on the one main surface 41A and the surface charges generated on the other main surface 41B are outputted to the outside.

According to the configuration illustrated in FIGS. 11 to 15, the electric signal based on the electric charge generated on the one main surface 41A side and the electric signal based on the electric charge generated on the other main surface 41B side are both extracted from the non-detection regions 41Bb and 41Bc of the other main surface 41B. In a case of providing a support 91 to support the infrared sensor element 4C and to extract the electric signals, the support 91 only needs to support the infrared sensor element 4C from the other main surface 41B side, and does not have to support the infrared sensor element 4C from the one main surface 41A side.

In the case of the configuration in which the electric signals are extracted from both the one main surface 41A and the other main surface 41B as illustrated in FIG. 6, providing a step in the support 91 makes it easier to extract the electric signals. On the other hand, as illustrated in FIG. 13, in the case of the configuration in which the electric signals are extracted from only one of the one main surface 41A and the other main surface 41B (only the other main surface 41B in the configuration illustrated in FIG. 13), the electric signals can be easily extracted even if there is no step in the support 91.

Such an example is illustrated in FIG. 16. FIG. 16 is a schematic cross-sectional view taken along line C-C in FIG. 11, illustrating a modification of the infrared sensor element and the support. In the configuration illustrated in FIG. 16, a space corresponding to the thickness of the pastes 921 and 922 can be formed between the support 91 and the pyroelectric element 41. In the configuration illustrated in FIG. 16, the support 91 has no steps, and thus a substrate made of glass epoxy or the like can be easily adopted as the support 91. In the configuration illustrated in FIG. 16, the length in the thickness direction 101 (in other words, height) can be reduced compared to the configuration illustrated in FIG. 6. Furthermore, the configuration illustrated in FIG. 16 allows for the use of an inexpensive support 91 with no steps.

### Second Exemplary Embodiment

FIG. 17 is a schematic diagram illustrating infrared radiation from a detection target to two infrared sensors according to an exemplary aspect. Specifically, a position detection system according to a second exemplary embodiment is different from the position detection system 1 according to the first embodiment in including two infrared sensors 21 and 22. Differences from the first embodiment will be described below. The same components as those of the position detection system 1 according to the first embodiment will be denoted by the same reference numerals, and description thereof will be basically omitted, but will be given as needed.

As illustrated in FIG. 17, an infrared sensor 2 of the position detection system according to the second embodiment includes the two infrared sensors 21 and 22. The position detection system also includes lenses 61 and 62 corresponding to the infrared sensors 21 and 22, respectively.

Each of the two infrared sensors 21 and 22 has the same configuration as the infrared sensor 2 of the position detection system 1 according to the first embodiment.

An infrared sensor element 4 of the infrared sensor 21 and an infrared sensor element 4 of the infrared sensor 22 are disposed side by side in the X-axis direction 103. The lens 61 is disposed facing the infrared sensor element 4 of the infrared sensor 21 in the optical axis direction 102. The lens 62 is disposed facing the infrared sensor element 4 of the infrared sensor 22 in the optical axis direction 102. The lenses 61 and 62 are disposed side by side in the X-axis direction 103. One main surface 41A of a pyroelectric element 41 of the infrared sensor 21 and one main surface 41A of a pyroelectric element 41 of the infrared sensor 22 are located on the same virtual plane. The one main surface 41A of the pyroelectric element 41 of the infrared sensor 21 and the one main surface 41A of the pyroelectric element 41 of the infrared sensor 22 are an example of counter surfaces.

According to the exemplary aspect, the control unit 3 (see FIG. 1) is electrically connected to each of the two infrared sensors 21 and 22.

The control unit 3 is configured to calculate an image center position k₁ in the infrared sensor 21 based on an electric signal outputted from the infrared sensor 21 to the control unit 3. The control unit 3 is also configured to calculate an image center position k₂ in the infrared sensor 22 based on an electric signal outputted from the infrared sensor 22 to the control unit 3.

The control unit 3 is then configured to calculate a difference between the two image center positions k₁ and k₂ thus calculated. In FIG. 17, the image center positions k₁ and k₂ are located opposite to each other across an optical axis 61A. Therefore, a difference k_{d} between the image center positions k₁ and k₂ is k_{d}=k₁−(−k₂)=k₁+k₂.

The control unit 3 is configured to calculate a distance L along the optical axis direction 102 between the centers C1 and C2 of the lenses 61 and 62 and the detection target 7, using Formula (8) below.

$$[ Math 8 ]$$

$$L = \frac{{D}_{1} {D}_{2}}{{k}_{d}} \qquad ( 8 )$$

In Formula (8), k_{d} is the difference between the image center positions k₁ and k₂. D₁ is the distance along the optical axis direction 102 between the centers C1 and C2 of the lenses 61 and 62 and the pyroelectric elements 41. D₂ is the distance along the X-axis direction 103 between the optical axis 61A of the lens 61 and an optical axis 62A of the lens 62. In other words, D₂ is the distance along the X-axis direction 103 between the axis AX of a parabola forming a curved outer edge portion of the infrared sensor 21 and the axis AX of a parabola forming a curved outer edge portion of the infrared sensor 22. The control unit 3 calculates the distance L based on k_{d}, D₁, and D₂.

Thus, according to the second exemplary embodiment, the distance between the infrared sensor 2 and the detection target 7 can be calculated.

Although the present invention has been fully described in connection with the preferred embodiments thereof with reference to the drawings as appropriate, various variations and modifications will become apparent to those skilled in the art. It is to be understood that such variations and modifications are included in the scope of the present invention defined in the appended claims without departing therefrom.

### REFERENCE SIGNS LIST

1 position detection system
2 infrared sensor
3 control unit
4 infrared sensor element
41 pyroelectric element
41A one main surface (counter surface) (also first main surface)
41Aa detection region
41Ab non-detection region
41Ac non-detection region
41B other main surface (second main surface)
41Ba detection region
41Bb non-detection region (first non-detection region)
41Bc non-detection region (second non-detection region)
42 one-side electrode (first-side electrode)
42A curved outer edge portion
42Aa curved outer edge portion (first curved outer edge portion)
42Ab curved outer edge portion (second curved outer edge portion)
43 other-side electrode (second-side electrode)
431 first electrode
432 second electrode
5 drive unit
6 lens
7 detection target
8 image
101 thickness direction
102 optical axis direction
103 X-axis direction
104 Y-axis direction

1. An infrared sensor element comprising:
a pyroelectric element having a first main surface facing a first side in a thickness direction and a second main surface that overlaps with the first main surface as viewed from a thickness direction and facing a second side in the thickness direction;
a first-side electrode on the first main surface; and
a second-side electrode on the second main surface and that overlaps the first-side electrode as viewed from the thickness direction,
wherein the first-side electrode or the second-side electrode has a curved outer edge portion that is parabolic in shape as viewed from the thickness direction.

2. The infrared sensor element according to claim 1, wherein each of the first main surface and the second main surface has a detection region and a non-detection region, and the detection region of the first main surface overlaps the detection region of the second main surface as viewed from the thickness direction.

3. The infrared sensor element according to claim 2, wherein the first-side electrode is disposed across the detection region of the first main surface and the non-detection region of the first main surface, and the first-side electrode has the curved outer edge portion in the detection region of the first main surface.

4. The infrared sensor element according to claim 3, wherein the second-side electrode is disposed across the detection region of the second main surface and the non-detection region of the second main surface.

5. The infrared sensor element according to claim 4, wherein a portion of the first-side electrode disposed in the detection region of the first main surface overlaps with a portion of the second-side electrode disposed in the detection region of the second main surface as viewed from the thickness direction.

6. The infrared sensor element according to claim 5, wherein the non-detection region of the first main surface on which the first-side electrode is disposed is located in a position away from the non-detection region of the second main surface on which the second-side electrode is disposed as viewed from the thickness direction.

7. The infrared sensor element according to claim 1, wherein the second main surface has a detection region, a first non-detection region, and a second non-detection region, and the first-side electrode has the curved outer edge portion.

8. The infrared sensor element according to claim 7, wherein the curved outer edge portion includes a first curved outer edge portion that overlaps with the detection region of the second main surface as viewed from the thickness direction.

9. The infrared sensor element according to claim 8, wherein the curved outer edge portion includes a second curved outer edge portion that overlaps the detection region of the second main surface as viewed from the thickness direction and is parallel to the first curved outer edge portion.

10. The infrared sensor element according to claim 9, wherein the second-side electrode includes:
a first electrode disposed across part of the detection region of the second main surface and the first non-detection region of the second main surface, and that overlaps with a portion of the first-side electrode having the first curved outer edge portion as viewed from the thickness direction, and
a second electrode electrically insulated from the first electrode and disposed across part of the detection region of the second main surface and the second non-detection region of the second main surface, and that overlaps with a portion of the first-side electrode having the second curved outer edge portion as viewed from the thickness direction.

11. An infrared sensor comprising:
the infrared sensor element according to claim 1;
a drive unit configured to move the pyroelectric element; and
a control unit configured to control the drive unit.

12. The infrared sensor according to claim 11, wherein the control unit is configured to sinusoidally drive the drive unit.

13. A position detection system comprising:
the infrared sensor according to claim 6; and
a lens that faces one of the first main surface and the second main surface in an optical axis direction parallel to the thickness direction.

14. The position detection system according to claim 13, wherein the lens is disposed so that an image formed on a counter surface that is one of the first main surface and the second main surface facing the lens by an infrared ray emitted from a detection target through the lens is formed from a first end to a second end of the counter surface in a Y-axis direction parallel to the counter surface and also to an axis of a parabola forming the curved outer edge portion, and is formed to be shorter than the counter surface in an X-axis direction parallel to the counter surface and orthogonal to the Y-axis direction.

15. The position detection system according to claim 14, wherein the control unit is configured to sinusoidally drive the drive unit to move the pyroelectric element along the X-axis direction, and to calculate an image center position, which is a position in the X-axis direction of a center of an image formed on the counter surface by an infrared ray emitted from the detection target through the lens, with respect to the axis of the parabola, based on an electric signal outputted from at least one of the first-side electrode or the second-side electrode in response to the movement of the pyroelectric element.

16. The position detection system according to claim 15, further comprising:
two infrared sensors,
wherein the counter surfaces of the two infrared sensors are located on a same plane.

17. The position detection system according to claim 16, wherein the control unit is configured to calculate the image center position for each of the two infrared sensors, and to calculate a distance between a center of the lens and the detection target along the optical axis direction, based on a difference between the two image center positions calculated, a distance between the center of the lens and the pyroelectric element along the optical axis direction, and a distance along the X-axis direction between an axis of a parabola forming the curved outer edge portion of one of the two infrared sensors and an axis of a parabola forming the curved outer edge portion of the other of the two infrared sensors.

18. An infrared sensor element comprising:
a pyroelectric element having a first main surface facing a first direction and a second main surface that overlaps with the first main surface in a thickness direction and that faces a second direction opposite the first direction;
a first-side electrode on the first main surface; and
a second-side electrode on the second main surface and that overlaps the first-side electrode in the thickness direction,
wherein at least one of the first-side electrode or the second-side electrode has a curved outer edge portion that has a concave shape as viewed from the thickness direction.

19. The infrared sensor element according to claim 18, wherein the curved outer edge portion is parabolic in shape as viewed from the thickness direction.

20. The infrared sensor element according to claim 18, wherein:
each of the first main surface and the second main surface has a detection region and a non-detection region,
the detection region of the first main surface overlaps the detection region of the second main surface in the thickness direction,
the first-side electrode is disposed across the detection region of the first main surface and the non-detection region of the first main surface, and
the first-side electrode has the curved outer edge portion in the detection region of the first main surface.
